(19) United States
(12) Patent Application Publication
(10) Pub. No.: US 2021/0087876 A1
(43) Pub. Date: Mar. 25, 2021

(54) SPACER DEVICE FOR SLATS OF ROLLING SHUTTERS OR ROLLING GATES

(71) Applicant: SIPAR S.R.L., Pian Camuno (BS) (IT)

(72) Inventor: Paolo ANDREOLI, Pian Camuno (BS) (IT)

(21) Appl. No.: 16/970,356

(22) PCT Filed: Feb. 8, 2019
(86) PCT No.: PCT/IB2019/051032

§ 371 Date: Aug. 15, 2020

(30) Foreign Application Priority Data
Feb. 15, 2018 (IT) 102018000002716

(51) Int. Cl. E06B 9/15

(52) U.S. Cl. CPC E06B 9/15; E06B 2009/1566

(57) ABSTRACT

A spacer device for slats of rolling shutters or rolling gates that slide in a first vertical guide and a second vertical guide opposed to one another comprises a first and a second connecting rods (2), each having at least one first slot (3, 4) connected via first pins (5) inside first seats (7) present on the opposed faces (8, 9) of a first slat (10) and connected via second pins (6) inside second seats (4) present on the opposed faces (17, 18) of a second slat (19), said first and second pins having a stem (20), which has a first end (21) that engages in first and second housings (22), present, respectively, on first and second caps (23, 24) for closing said opposed faces of said first and second slats, and a second end (25), opposite to said first end, that engages in said first and second seats (7, 16).

### BACKGROUND OF THE INVENTION

The present invention relates to a spacer device for slats of rolling shutters or rolling gates.

As is known, there are various types of rolling shutters and rolling gates currently present on the market, normally defined by a plurality of horizontal slats associated with one another so that they can be rolled about a winding roller that can be activated in rotation manually or by means of a motor reducer.

Current rolling shutters or rolling gates have two vertical guides, inside which the slats are able to slide to enable raising or lowering of the rolling shutter or rolling gate via the winding roller.

Among the various types of rolling shutters or rolling gates, one presents the possibility of spacing the slats that make them up apart so as to enable airing and/or lighting of the premises in which they are present.

In this way, the rolling shutter or rolling gate, thanks to the partial spacing of the slats, has both the function of total darkening as well as providing a shield against the sun and/or against the wind.

To be able to space apart slats of rolling shutters or rolling gates of this type in an adequate way, various devices have been developed, which however, have the drawback of adapting rather badly to the traditional slide guides and/or to winding of the rolling shutter or rolling gate around the winding roller.

Current devices, above all, have a lack of strength during use over prolonged periods of time on account of the fact that the joints between the slats are subjected to considerable stresses during raising, lowering, and rolling thereof on the winding roller.

The forces to which known spacer devices for slats are subjected give rise, on the various elements, to considerable forces of friction and early wear thereof, forcing the user to frequent replacements.

Moreover, known devices are not suitable for spacing the slats apart by amounts variable between groups of slats or between all the slats in so far as, to obtain such differentiation, they call for complete replacement thereof.

The patent DE3336280A1 regards to a spacer device for slats of rolling shutters or rolling gates. This device, however, does not have first and second caps for closing the slats that prevent the pins from slipping out of the slats.

### SUMMARY OF THE INVENTION

The aim of the present invention is to provide a spacer device for slats of rolling shutters or rolling gates that will overcome the drawbacks of the prior art referred to above.

In the framework of the above aim, an object of the present invention is to provide a spacer device for slats of rolling shutters or rolling gates that is sturdy and perfectly suitable for pre-existing guides and winding rollers.

Yet another object is to provide a spacer device for slats of rolling shutters or rolling gates that will be free from undesired friction and early wear also for rolling shutters or rolling gates of considerable dimensions.

Yet a further object is to provide a spacer device for slats of rolling shutters or rolling gates in which it will be possible to carry out fast and easy replacement of any element that makes it up.

Not the least important object is to provide a spacer device for slats of rolling shutters or rolling gates that will make it possible to space groups of slats apart easily by a variable distance without total removal and replacement thereof.

The above aim, as well as the above and other objects, are achieved by a spacer device for slats of rolling shutters or rolling gates that slide in a first and a second vertical guides opposed to each other, characterized in that it comprises a first and a second connecting rods, each having at least one first slot connected via first pins inside first seats present on the opposed faces of a first slat and connected via second pins inside second seats present on the opposed faces of a second slat, said first and second pins having a stem that has a first end which engages in first and second housings present, respectively, on first and second caps for closing said opposed faces of said first and second slats, and a second end, opposite to said first end, which engages in said first and second seats.

The dependent claims specify more completely further characteristics of the spacer device for slats of rolling shutters or rolling gates according to the present invention.

In particular, the first end has a widened head having a shape that mates with that of the first and second housings.

Each stem has, beside the head, an annular thickened portion having a diameter larger than that of the first and second seats.

The annular thickened portion internally engages at least one first slot of the first and second connecting rods.

The annular thickened portion has a length greater than the thickness at least of the first slot.

The first and second connecting rods each have a partition.

The partition defines a first and a second half-slots that engage with the first and second pins, respectively.

The first and second connecting rods and the first and second caps have a radius of curvature equal to that of the first and second slats.

The first and second connecting rods have a length shorter than the height of each of said first and second slats.

The first and second retention caps each have two wings, which each have the housing for the widened head.

The first and second retention caps each have a projection, which extends orthogonally from the wings and is designed to engage with a central seat of the first and second slats.

The housing has a cylindrical shape for rotatably housing the widened head.

Forming a subject of the present invention is also a rolling shutter or rolling gate with horizontal slats, characterized in that it comprises at least one spacer device for said slats that has one or more of the characteristics claimed in one or more of the claims 1 to 9.

### BRIEF DESCRIPTION OF THE DRAWINGS

The above characteristics and advantages of the present invention will emerge more clearly from the following description, which is provided purely by way of indicative and non-limiting example, of a preferred but not exclusive embodiment of a spacer device for slats of rolling shutters or rolling gates illustrated in the attached drawings, wherein:

FIG. 1 is a front elevation view of the device associated with a first slat and a second slat according to the present invention;

FIG. 2 is an exploded perspective view of the left-hand side of the device of FIG. 1 according to the present invention;

FIG. 3 is a side elevation view in cross-section of the left-hand side of the device according to the present invention;

FIG. 4 is a perspective view of the first cap according to the present invention;

FIG. 5 is a perspective view of the first pin according to the present invention; and

FIG. 6 is a perspective view of the first connecting rod according to the present invention.

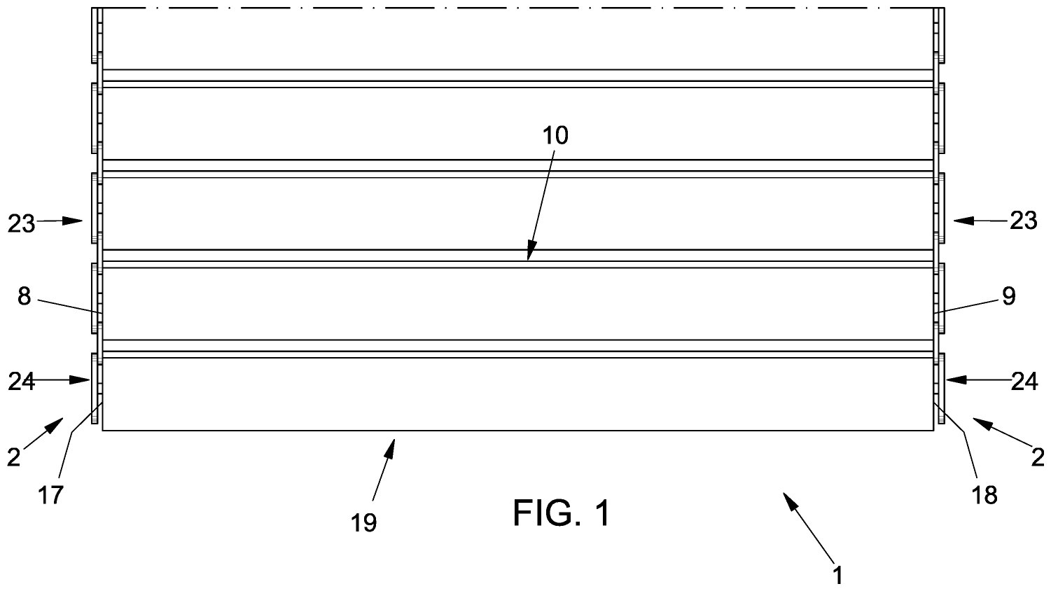

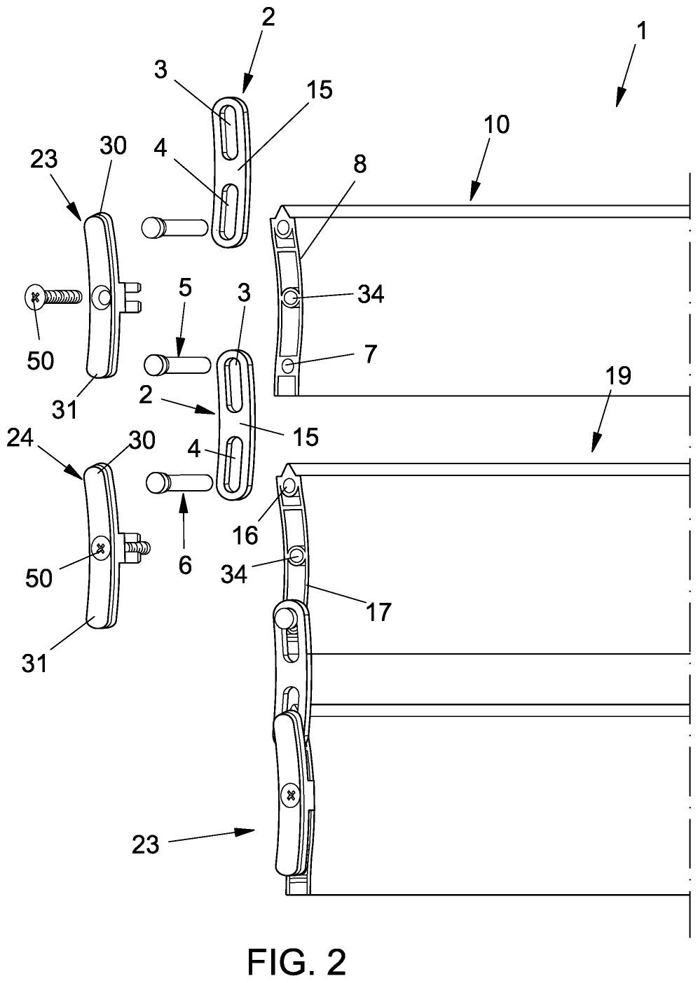

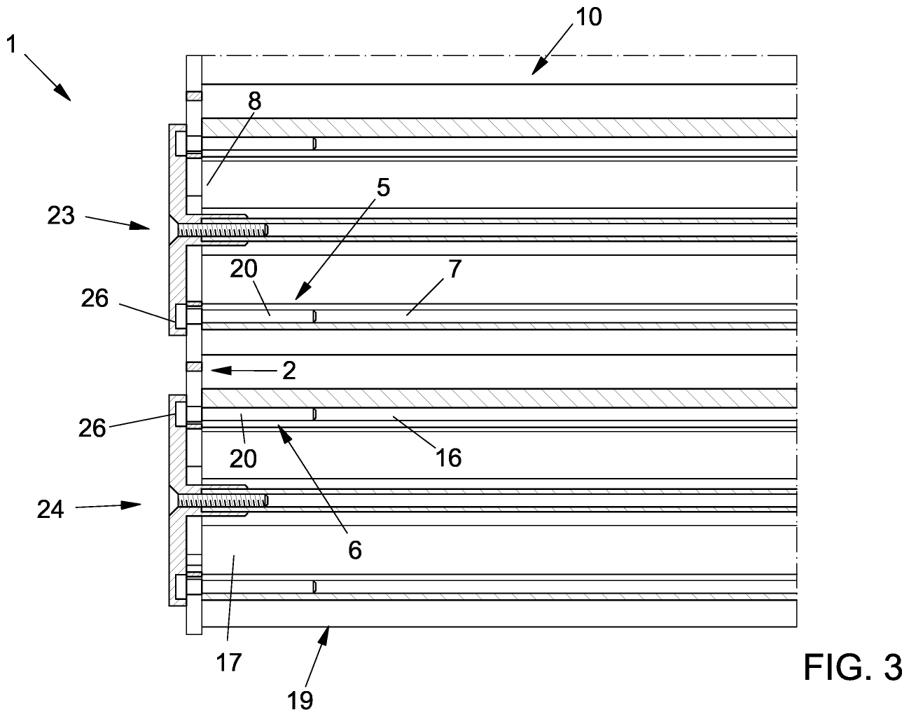

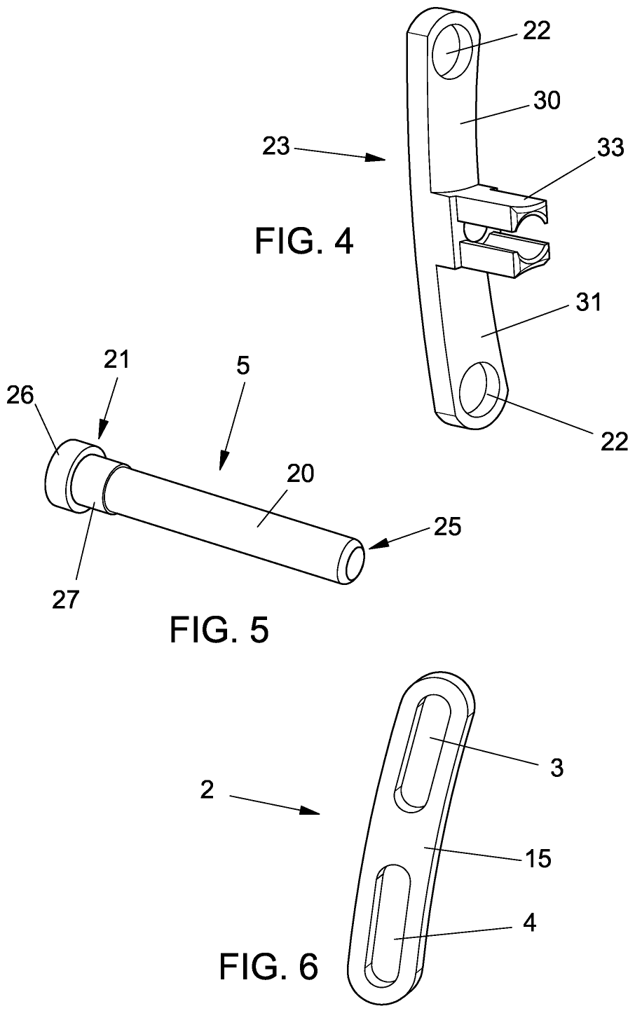

### DESCRIPTION OF THE PREFERRED EMBODIMENTS

With particular reference to the figures described above, the spacer device for slats of rolling shutters or rolling gates according to the present invention is designated, as a whole, by the reference number 1.

The spacer device 1 is applied to rolling shutters or rolling gates that slide in a first and a second vertical guides (not represented) opposed to one another.

The device 1 comprises a first and a second connecting rods, designated as a whole by the numeral 2, each having at least one first slot that, preferably but not necessarily, has a partition 15 that divides the slot into a first and a second half-slot 3 and 4, which engage, respectively, first and second pins designated generically by numerals 5 and 6.

The first half-slot 3 is connected via the first pins 5 inside first seats 7 present on the opposed faces 8 and 9 of a first slat 10.

The second half-slot 4 is connected via the second pins 6 inside second seats 16 present on the opposed faces 17 and 18 of a second slat 19.

The first and second pins 5 and 6 each have a stem 20 having a first end 21 that engages in first and second housings 22 present, respectively, on first and second caps 23 and 24 closing the opposed faces 8 and 9 and 17 and 18 of the first and second slats 10 and 19.

The stem 20 has a second end 25, opposite to the first end, which engages in the first and second seats 7 and 16.

In particular, in a preferred solution, the first end 21 has a widened head 26, having a cylindrical shape that mates with that of the first and second housings 22 so that it can be withheld by the latter both radially and axially.

Each stem 20 has, beside the head 26, an annular thickened portion 27 having a diameter larger than that of the first and second seats 7 and 16 and a length greater than the thickness of the first and second half-slots 3 and 4.

In this way, the stem is housed inside the first and second seats 7 and 16 as far as the annular thickened portion 27, which functions as spacer between the opposed faces of the slats 10 and 19 in such a way as to enable the first and second connecting rods 2 to move freely and without friction with respect to the slats 10 and 19.

Moreover, the annular thickened portion thus structured engages in the first and second half-slots 3 and 4, guaranteeing a greater resistance to shear stresses and friction that are exerted thereon by the connecting rods during movement of the rolling shutter.

To guarantee perfect winding on the winding roller, both the first and the second connecting rods 2, together with the first and second caps 23 and 24, have a radius of curvature equal to that of the slats.

In addition, in order to enable perfect contact between the slats when the rolling shutter is totally closed, the first and second connecting rods 2 have a length shorter than the height of each of the slats themselves.

Advantageously, moreover, the first and second caps each have two wings 30 and 31, present on which are the housings 20 and, in a central position, a projection 33, which extends orthogonally from the wings and is designed to engage with a central seat 34 of the first and second slats 10 and 19.

The caps are fixedly connected in the seats 34 via a self-tapping screw (not represented), and simultaneously perform various functions.

In the case where the pins 5 and 6 are rotatably housed in the seats 7 and 16, each cap has the function, not only of closing the slats, but also of preventing the pins from slipping out of them, also guaranteeing a possible rotation movement thereof during movement of the connecting rods so as to reduce friction on the annular thickened portion.

In the case, instead, where the pins are housed with interference in the respective seats, the caps have, not only the function of closing the slats, but also that of preventing them from undergoing bending, thus avoiding friction due to undesired contacts and guaranteeing a greater duration thereof.

The spacer device for slats of rolling shutters or rolling gates thus conceived may undergo modifications and variations, all of which fall within the inventive idea; moreover, the materials used may be any according to the needs.

1. A spacer device for slats of rolling shutters or rolling gates that slide in a first vertical guide and a second vertical guide that are opposed to one another, said spacer device comprising a first and a second connecting rods (2), each having at least one first slot (3, 4) connected via first pins (5) inside first seats (7) present on the opposed faces (8, 9) of a first slat (10) and connected via second pins (6) inside second seats (16) present on the opposed faces (17, 18) of a second slat (19), characterized in that said first and second pins have a stem (20) having a first end (21) which engages in first and second housings (22) present on first and second caps (23, 24), respectively, and a second end (25), opposite to said first end, which engages in said first and second seats (7, 16), said first and second caps (23, 24) closing said opposed faces (8, 9; 17, 18), respectively, of said first and second slats (10, 19) and preventing said first and second pins (5, 6) from slipping out of said first and second seats (7, 16) and from bending.

2. The spacer device according to claim 1, characterized in that said first end (21) has a widened head (26), which has a shape that mates with that of said first and second housings (22).

3. The spacer device according to claim 2, characterized in that said stem has, beside said widened head, an annular thickened portion (27) having a diameter larger than that of said first and second seats, said annular thickened portion engaging inside said at least one first slot of said first and second connecting rods.

4. The spacer device according to claim 3, characterized in that said annular thickened portion has a length greater than the thickness of said at least one first slot of said first and second connecting rods.

5. The spacer device according to claim 1, characterized in that said first and second connecting rods each have a partition (15) that divides said at least one first slot defining a first half-slot (3) and a second half-slot (4), which engage with said first and second pins, respectively.

6. The spacer device according to claim 1, characterized in that said first and second connecting rods and said first and second caps have a radius of curvature equal to that of said first and second slats.

7. The spacer device according to claim 1, characterized in that said first and second connecting rods have a length shorter than the height of each of said first and second slats.

8. The spacer device according to claim 1, characterized in that said first and second caps each have a first wing (30) and a second wing (31), which have said respective first and second housings for said first end, and a projection (33) extending orthogonally from said wings and designed to engage with a central seat (34) of said first and second slats.

9. The spacer device according to claim 1, characterized in that said housing has a cylindrical shape for rotatably housing said widened head, which has a shape that mates therewith.

10. A rolling, shutter or rolling gate with horizontal slats, characterized in that it comprises at least one spacer device for said slats, which has one or more of the characteristics according to claim 1.
